(19) United States
(12) Patent Application Publication
(10) Pub. No.: US 2012/0162662 A1
(43) Pub. Date: Jun. 28, 2012

(54) Actively Mode Locked Laser Swept Source for OCT Medical Imaging

(75) Inventors: Bartley C. Johnson, North Andover, MA (US); Dale C. Flanders, Lexington, MA (US)

(73) Assignee: AXSUN TECHNOLOGIES, INC., Billerica, MA (US)

(21) Appl. No.: 12/979,225

(22) Filed: Dec. 27, 2010

(51) Int. Cl. G01B 11/02; H01S 3/098

(52) U.S. Cl. 356/496; 372/18

(57) ABSTRACT

An optical coherence analysis system uses a laser swept source that is constrained to operate in a mode locked condition. This is accomplished by synchronously changing the laser cavity's gain and/or phase based on the round trip travel time of light in the cavity. This improves high speed tuning by taking advantage of frequency shifting mechanisms within the cavity and avoids chaotic laser behavior.

### BACKGROUND OF THE INVENTION

Optical coherence analysis relies on the use of the interference phenomena between a reference wave and an experimental wave or between two parts of an experimental wave to measure distances and thicknesses, and calculate indices of refraction of a sample. Optical Coherence Tomography (OCT) is one example technology that is used to perform high-resolution cross sectional imaging. It is often applied to imaging biological tissue structures, for example, on microscopic scales in real time. Optical waves are reflected from an object or sample and a computer produces images of cross sections of the object by using information on how the waves are changed upon reflection.

Fourier domain OCT (FD-OCT) currently offers the best performance for many applications. Moreover, of the Fourier domain approaches, swept-source OCT has distinct advantages over techniques such as spectrum-encoded OCT because it has the capability of balanced and polarization diversity detection. It has advantages as well for imaging in wavelength regions where inexpensive and fast detector arrays, which are typically required for spectrum-encoded FD-OCT, are not available.

In swept source OCT, the spectral components are not encoded by spatial separation, but they are encoded in time. The spectrum is either filtered or generated in successive frequency steps and reconstructed before Fourier-transformation. Using the frequency scanning swept source, the optical configuration becomes less complex but the critical performance characteristics now reside in the source and especially its frequency tuning speed and accuracy.

High speed frequency tuning for OCT swept sources is especially relevant to in vivo imaging where fast imaging reduces motion-induced artifacts and reduces the length of the patient procedure. It can also be used to improve resolution.

The swept sources for OCT systems have typically been tunable lasers. The advantages of tunable lasers include high spectral brightness and relatively simple optical designs. A tunable laser is constructed from a gain medium, such as a semiconductor optical amplifier (SOA), that is located within a resonant cavity, and a tunable element such as a rotating grating, grating with a rotating mirror, or a Fabry-Perot tunable filter. Currently, some of the highest tuning speed lasers are based on the laser designs described in U.S. Pat. No. 7,415,049 B1, entitled Laser with Tilted Multi Spatial Mode Resonator Tuning Element, by D. Flanders, M. Kuznetsov and W. Atia. The use of micro-electro-mechanical system (MEMS) Fabry-Perot tunable filters combines the capability for wide spectral scan bands with the low mass, high mechanical resonant frequency deflectable MEMS membranes that have the capacity for high speed tuning.

Certain tradeoffs in laser design, however, can be problematic for OCT systems. Generally, shorter laser cavities translate to higher potential tuning speeds, since laser oscillation must build up anew from spontaneous emission when the laser is tuned. Thus, round-trip travel time for the light in the laser cavities should be kept low so that this build up occurs quickly. Short laser cavities, however, create problems in terms of the spectral spacing of the longitudinal cavity modes of the laser. That is, lasers can only produce light at integer multiples of the cavity mode spacing since the light must oscillate within the cavities. Shorter cavities result in fewer and more widely spaced modes. This results in greater mode hopping noise as the laser is tuned over these discrete cavity modes. So, when designing an OCT laser, there is typically a need to choose between low noise and high speed.

One laser design seeks to address this drawback. A Fourier-domain mode-locked laser (FDML) stores light in a long length of fiber for amplification and recirculation in synchronism with the laser's tuning element. See “Fourier Domain Mode Locking (FDML): A new laser operating regime and applications for optical coherence tomography”, R. Huber, M. Wojtkowski, and J. G. Fujimoto, 17 Apr. 2006/Vol. 14, No. 8/OPTICS EXPRESS 3225. The drawback of these devices is their complexity, however. Moreover, the ring cavity including the long storage fiber creates its own performance problems such as dispersion and stability.

### SUMMARY OF THE INVENTION

The present invention concerns a mode-locked laser. It leverages an optical frequency shifting mechanism inside the laser cavity for stable operation. Specifically, a four-wave mixing effect is used that red shifts the wave in the laser cavity. This facilitates the tuning to lower optical frequencies.

In general, according to one aspect, the invention features an optical coherence imaging method. This comprises providing a tunable laser with a ring or linear-cavity to generate a tunable optical signal in a mode-locked condition, transmitting the tunable optical signal to an interferometer having a reference arm and a sample arm in which a sample is located, detecting the tunable optical signal returning from the sample arm and the reference arm, and generating image information of the sample from the detected tunable optical signal.

In the preferred embodiment, controlling the tunable laser to generate the tunable optical signal in the mode-locked condition comprises controlling a bias current to an optical gain element that amplifies light in the cavity such as by modulating a bias current at frequencies harmonically related to the cavity's round-trip frequency.

Preferably the cavity of the laser is at least 50 millimeters long. This reduces mode hopping noise. At the same time, the laser can be tuned at greater than 50 kHz.

In general, according to one aspect, the invention features an optical coherence analysis system. This system comprises a tunable laser for generating a tunable optical signal that is frequency tuned over a scan band. The tunable laser includes a mode locking system for constraining the tunable laser to operate in a mode-locked condition as the tunable laser is frequency tuned. An interferometer divides the tunable optical signal between a reference arm leading to a reference reflector and a sample arm leading to a sample. A detector system detects an interference signal generated from the tunable optical signal from the reference arm and from the sample arm.

In the current embodiment, the tunable laser comprises a semiconductor gain medium and a tuning element for controlling a frequency of the tunable optical signal. And, the mode locking system comprises a modulated bias current source that supplies a modulated bias current to the semiconductor gain medium. The source includes, for example, a radio frequency signal generator and a bias current source. The radio frequency signal generator modulates at a frequency based on a roundtrip travel time of light in the cavity.

In other examples, the mode locking system comprises a phase modulator in the cavity. Preferably, the cavity has a length of at least 40 millimeters and the tunable signal is scanned over a scan band at greater than 50 kHz.

In general according to another aspect, the invention features an actively mode-locked tunable laser, comprising a tunable filter in a laser cavity for frequency tuning a tunable signal generated by the tunable laser, and a semiconductor optical amplifier for amplifying light in the laser cavity and providing four-wave mixing that red shifts light within the cavity facilitating tuning to lower frequencies.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a top plan scale drawing of the mode-locked laser swept source for optical coherence analysis according to a first embodiment the present invention;

FIG. 2 is a schematic drawing of the mode-locked laser swept source for optical coherence analysis according to a second embodiment the present invention;

FIG. 3 is a plot of modulated signal (e.g., SOA bias current) of the mode locking system, the laser pulses circulating in the laser cavity, the gain of the semiconductor gain medium, and the gain medium's refractive index as a function of time;

FIG. 4 is a schematic view of an OCT system incorporating the mode-locked laser swept source according to an embodiment of the invention; and

FIG. 5 includes a plot of k-clock frequency during the frequency scan of the swept source, a plot of the power output showing regions of high and low relative intensity noise (RIN), and a spectrogram showing the frequency content vs. time of the laser's instantaneous power output

### DETAILED DESCRIPTION OF THE PREFERRED EMBODIMENTS

In the preferred embodiment, the inventive OCT system includes a laser 100 that has a mode locking system that induces the laser 100 to operate in a mode-locked condition. This has the effect of stabilizing the operation of the laser and avoiding noisy disruptions due to uncertainty in the number of pulses circulating in the cavity. Instead, the mode locking system stabilizes the pulsation behavior of the laser 100 by modulating a gain in the cavity 110 of the laser 100. In the current embodiment, the gain of the cavity is modulated by modulation of the gain medium at a harmonic of the cavity round trip frequency. In other embodiments described below, the modulation is accomplished by modulating an intracavity phase modulator.

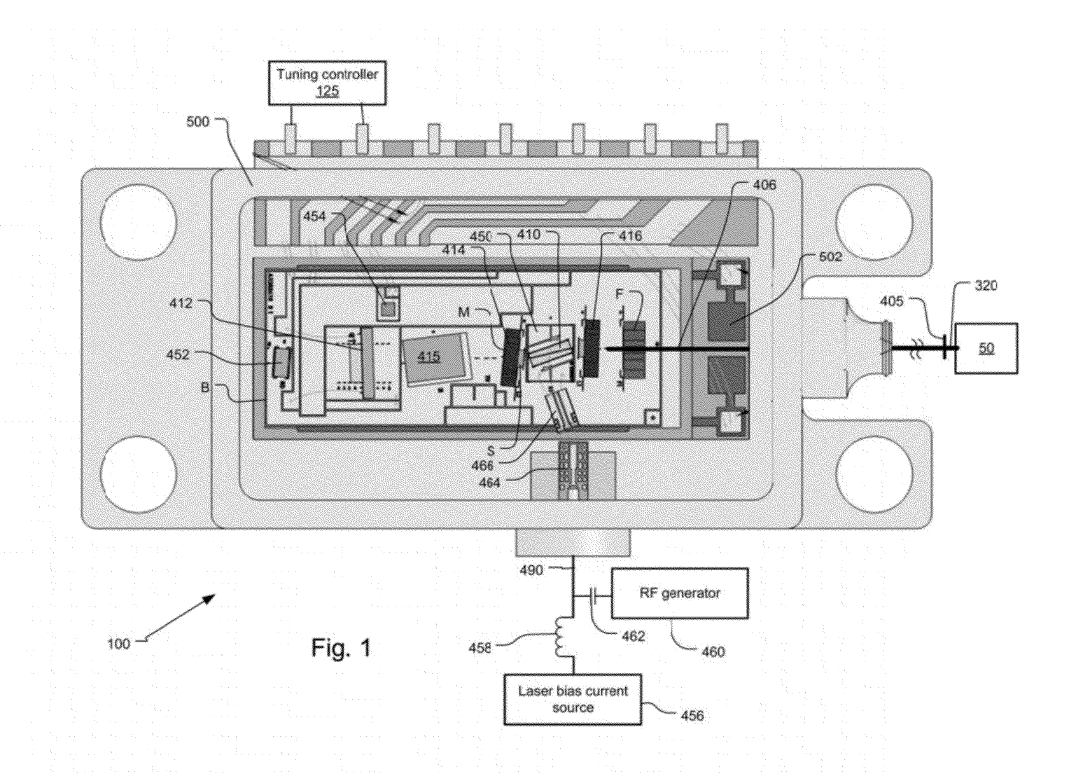

FIG. 1 shows mode-locked laser swept source 100 for optical coherence analysis, which has been constructed according to the principles of the present invention. This embodiment facilitates the mode-locked operation by modulating the bias current to an intracavity gain element.

In the current embodiment, the laser swept source 100 is preferably a laser as generally described in incorporated U.S. Pat. No. 7,415,049 B1. It includes a linear cavity with a gain element and a Fabry-Perot filter frequency tuning element defining one end of the cavity.

In other embodiments, other cavity configurations are used such as ring cavities. Further other cavity tuning elements are used such as gratings. These elements can also be located entirely within the cavity such as an angle isolated Fabry-Perot tunable filter or grating.

In more detail with respect to the current embodiment, the tunable laser 100 comprises a semiconductor gain chip 410 that is paired with a micro-electro-mechanical (MEMS) angled reflective Fabry-Perot tunable filter 412, which defines one end of the laser cavity. The cavity extends to a second output reflector 405 that is located at the end of a fiber pigtail 406 that is coupled to the bench and also forms part of the cavity.

Preferably, the length of the cavity is at least 40 millimeters long and preferably over 50 to 80 mm. This ensures close longitudinal mode spacing that reduces mode hopping noise.

Light passing through the output reflector 405 is transmitted on optical fiber 320 or via free space to an interferometer 50 of the OCT system.

The semiconductor optical amplifier (SOA) chip 410 is located within the laser cavity. In the current embodiment, input and output facets of the SOA chip 410 are angled and anti-reflection (AR) coated, providing parallel beams from the two facets. In the preferred embodiment, the SOA chip 410 is bonded or attached to the common bench B via a submount 450.

The material system of the chip 410 is selected based on the desired spectral operating range. Common material systems are based on III-V semiconductor materials, including binary materials, such as GaN, GaAs, InP, GaSb, InAs, as well as ternary, quaternary, and pentenary alloys, such as InGaN, InAlGaN, InGaP, AlGaAs, InGaAs, GaInNAs, GaInNAsSb, AlInGaAs, InGaAsP, AlGaAsSb, AlGaInAsSb, AlAsSb, InGaSb, InAsSb, and InGaAsSb. Collectively, these material systems support operating wavelengths from about 400 nanometers (nm) to 2000 nm, including longer wavelength ranges extending into multiple micrometer wavelengths. Semiconductor quantum well and quantum dot gain regions are typically used to obtain especially wide gain and spectral emission bandwidths. Currently, edge-emitting chips are used although vertical cavity surface emitting laser (VCSEL) chips are used in different implementations.

The use of a semiconductor chip gain medium 410 has advantages in terms of system integration since semiconductor chips can be bonded to submounts that in turn are directly bonded to the bench B. Other possible gain media can be used in other implementations, however. Such examples include solid state gain media, such as rare-earth (e.g., Yb, Er, Tm) doped bulk glass, waveguides or optical fiber.

Each facet of the SOA 410 has an associated lens structure 414, 416 that is used to couple the light exiting from either facet of the SOA 410. The first lens structure 414 couples the light between the back facet of the SOA 410 and the reflective Fabry-Perot tunable filter 412. Light exiting out the output or front facet of the SOA 410 is coupled by the second lens structure 416 to a fiber end facet of the pigtail 406.

Each lens structure comprises a LIGA mounting structure M, which is deformable to enable post installation alignment, and a transmissive substrate S on which the lens is formed. The transmissive substrate S is typically solder or thermocompression bonded to the mounting structure M, which in turn is solder bonded to the optical bench B.

The fiber facet of the pigtail 406 is also preferably mounted to the bench B via a fiber mounting structure F, to which the fiber 406 is solder bonded. The fiber mounting structure F is likewise usually solder bonded to the bench B.

The angled reflective Fabry-Perot filter 412 is a multi-spatial-mode tunable filter that provides angular dependent reflective spectral response back into the laser cavity. This characteristic is discussed in more detail in incorporated U.S. Pat. No. 7,415,049 B1.

Preferably, the tunable filter 412 is a Fabry-Perot tunable filter that is fabricated using micro-electro-mechanical systems (MEMS) technology and is attached, such as directly solder bonded, to the bench B. Currently, the filter 412 is manufactured as described in U.S. Pat. No. 6,608,711 or 6,373,632, which are incorporated herein by this reference. A curved-flat resonator structure is used in which a generally flat mirror and an opposed curved mirror define a filter optical cavity, the optical length of which is modulated by electrostatic deflection of at least one of the mirrors.

Any light transmitted through the tunable filter 412 is directed to a beam dump component 452 that absorbs the light and prevents parasitic reflections in the hermetic package 500.

The mode-locked laser swept source 100 and the other embodiments discussed hereinbelow are generally intended for high speed tuning to generate tunable optical signal that scans over the scanband at speeds greater than 10 kiloHertz (kHz). In current embodiments, the mode-locked laser swept source 100 tunes at speeds greater than 50 or 100 kHz. In very high speed embodiments, the mode-locked laser swept source 100 tunes at speeds greater than 200 or 500 kHz, or faster.

The tuning controller 125 provides a tuning voltage function to the Fabry-Perot filter 412 that sweeps the passband optical frequency across the tuning band, preferably with optical frequency varying linearly with time.

The tuning speed provided by the tuning controller 125 is also expressed in wavelength per unit time. In one example, for an approximately 110 nm tuning range or scan band and 100 kHz scan rate, assuming 60% duty cycle for substantially linear up-tuning, the peak sweep speed would be 110 nm*100 kHz/0.60=18,300 nm/msec=18.3 nm/μsec or faster. In another example, for an approximately 90 nm tuning range and 50 kHz scan rate, assuming a 50% duty cycle for substantially linear up-tuning, the peak sweep speed is 90 nm*50 kHz/0.50=9,000 nm/msec=9.0 nm/μsec or faster. In a smaller scan band example having an approximately 30 nm tuning range and 2 kHz scan rate, assuming a 80% duty cycle for substantially linear tuning, the peak sweep speed would be 30 nm*2 kHz/0.80=75 nm/msec=0.075 nm/μsec, or faster.

Thus, in terms of scan rates, in the preferred embodiments described herein, the sweep speeds are greater than 0.05 nm/μsec, and preferably greater than 5 nm/μsec. In still higher speed applications, the scan rates are higher than 10 nm/μsec.

In one implementation, an extender element 415 is added to the laser cavity. This is fabricated from a transparent high refractive index material, such as fused silica, silicon, GaP or other transmissive material having a refractive index of ideally about 1.5 or higher. Currently silicon or GaP is preferred. Both endfaces of the extender element 415 are antireflection coated. Further, the element are preferably angled by between 1 and 10 degrees relative to the optical axis of the cavity to further spoil any reflections from the endfaces from entering into the laser beam optical axis.

The extender element 415 is used to change the optical distance between the laser intracavity spurious reflectors and thus change the depth position of the spurious peak in the image while not necessitating a change in the physical distance between the elements.

The bench B is termed a micro-optical bench and is preferably less than 10 millimeters (mm) in width and about 25 mm in length or less. This size enables the bench to be installed in a standard, or near standard-sized, butterfly or DIP (dual inline pin) hermetic package 500. In one implementation, the bench B is fabricated from aluminum nitride. A thermoelectric cooler 502 is disposed between the bench B and the package 500 (attached/solder bonded both to the backside of the bench and inner bottom panel of the package) to control the temperature of the bench B. The bench temperature is detected via a thermistor 454 installed on the bench B.

The mode locking system of the illustrated embodiment includes a bias current modulation system. In more detail, a laser bias current source 456 supplies a direct current for the bias current supplied to the SOA 410. This current passes through an inductor 458. A radio frequency generator 460 generates an electronic signal having a frequency of a harmonic of the cavity round trip frequency. This frequency corresponds to the time required for light to make a round trip in the cavity of the laser 100. In the illustrated laser, this corresponds to twice the time required for light to propagate from the tunable filter 412 at one end of the cavity to the output reflector 405 at the end of the pigtail 406.

The signal from the RF generator is supplied through a capacitor 462 such that the capacitor 462 in combination with the inductor 458 yield a modulated bias current 490 that is delivered to the SOA 410 via a package impedance-matched stripline 464 and a bench-mounted impedance-matched stripline 466.

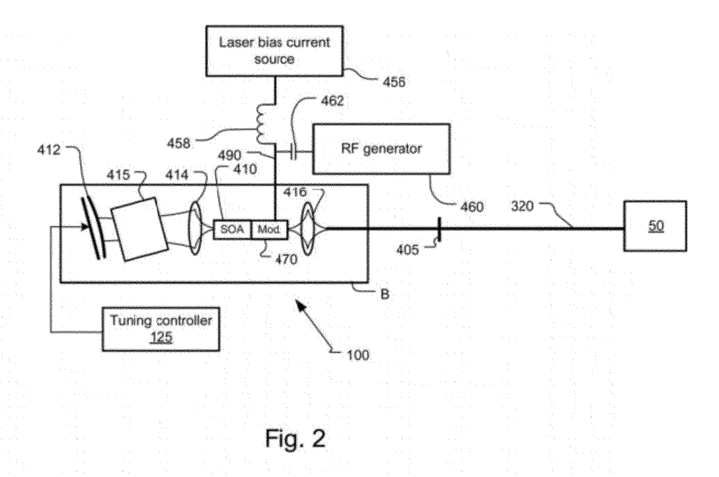

FIG. 2 illustrates a second embodiment in which the mode locking system is implemented as an in-cavity phase modulator.

In more detail, a phase modulator is added into the cavity. In one embodiment, the phase modulator is installed on the bench B between the SOA 410 and the lens structure 416. In the preferred embodiment, it is a semiconductor chip that is integral with the SOA chip 410 and specifically a phase modulation section to which a separate, modulated bias current or Voltage is supplied.

Preferably, the modulation to the phase modulator 470 is supplied as described previously using a radio frequency generator 460 that generates a modulated signal at a harmonic of the cavity round trip frequency. The signal from the RF generator 460 is supplied through a capacitor 462 such that the capacitor 462 in combination with the inductor 458 yield a modulated bias current or voltage 490 that is delivered to the phase modulator 470.

The various embodiments of the mode locking system facilitate the rapid wavelength tuning by leveraging optical frequency shifting mechanisms inside the laser cavity for stable operation. Without these mechanisms, laser oscillation must build up anew from spontaneous emission when the laser is tuned. A four-wave mixing effect red shifts the optical wave within the cavity.

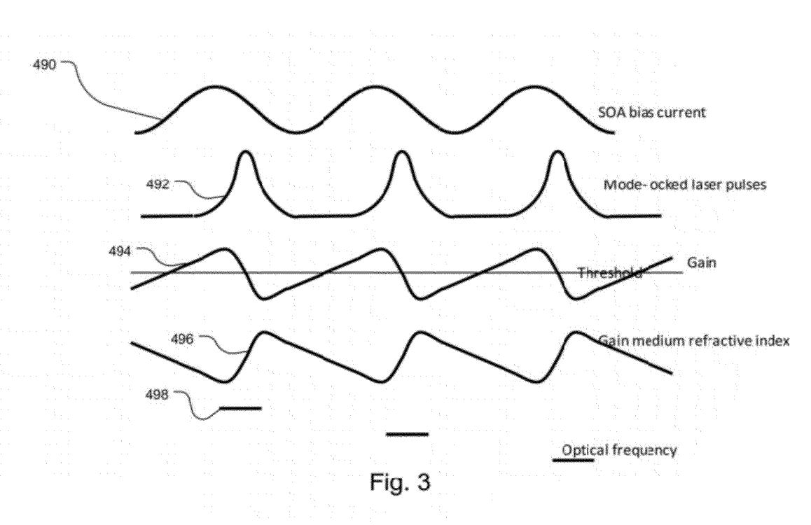

FIG. 3 illustrates the four wave mixing process. The purpose of this diagram is to describe, in a physical way, the red-shift mechanism in the four-wave-mixing process. The mode-locked operation of the laser 100 yields a mode of operation in which one or more pulses circulate in the laser's cavity. When a light pulse 492 passes through the semiconductor diode gain medium, it depletes the gain 494, and the gain recovers through current injection between pulses. The gain modulation is accompanied by a modulation in the real part of the refractive index 496. The power gain (g) (in 1/length units) is linked to the index (n) through the linewidth enhancement factor α:

$$Δ n = - α \frac{λ}{4 π} Δ g$$

The optical length of the chip increases while the pulse is passing through, which red shifts the pulse in a process similar to a Doppler shift.

Since α is positive for most semiconductor lasers, the optical frequency shift per round trip is negative. The wavelength is red shifted yielding a decrease in the optical frequency 498.

The mode locking system generates the modulated signal 490 that constrains the tunable laser 100 to operate in a mode locked condition. Specifically, the cavity's gain is modulated synchronously with the mode-locked laser pulses 492 traveling in the cavity of the laser 100. This prevents chaotic pulsation and cleans up the clock jitter and relative intensity noise (RIN).

In other embodiments, the mode locking system is driven with more complex waveforms (non-sinusoids) synchronized to the round trip of the cavity. This may permit both blue and red shifting of pulses to either change the tuning direction or to reduce the tuning rate by red shifting some pulses and blue shifting others to reduce the overall tuning rate.

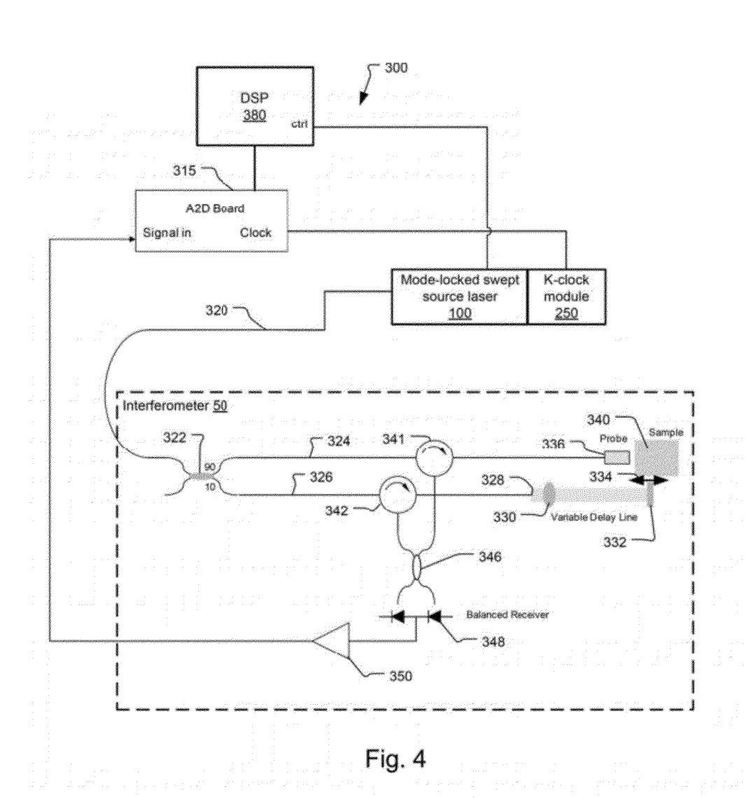

FIG. 4 shows an optical coherence analysis system 300 using the mode locked laser source 100, which has been constructed according to the principles of the present invention.

The laser 100 generates a tunable optical signal on optical fiber 320 that is transmitted to interferometer 50. The tunable optical signal scans over a scanband with a narrowband emission.

Preferably, a k-clock module 250 is used to generate a clocking signal at equally spaced optical frequency increments as the optical signal is tuned over the scan band.

In the current embodiment, a Mach-Zehnder-type interferometer 50 is used to analyze the optical signals from the sample 340. The tunable signal from the laser source 100 is transmitted on fiber 320 to a 90/10 optical coupler 322. The combined tunable signal is divided by the coupler 322 between a reference arm 326 and a sample arm 324 of the system.

The optical fiber of the reference arm 326 terminates at the fiber endface 328. The light exiting from the reference arm fiber endface 328 is collimated by a lens 330 and then reflected by a mirror 332 to return back, in some exemplary implementations.

The external mirror 332 has an adjustable fiber to mirror distance (see arrow 334), in one example. This distance determines the depth range being imaged, i.e. the position in the sample 340 of the zero path length difference between the reference arm 326 and the sample arm 324. The distance is adjusted for different sampling probes and/or imaged samples. Light returning from the reference mirror 332 is returned to a reference arm circulator 342 and directed to a 50/50 fiber coupler 346.

The fiber on the sample arm 324 terminates at the sample arm probe 336. The exiting light is focused by the probe 336 onto the sample 340. Light returning from the sample 340 is returned to a sample arm circulator 341 and directed to the 50/50 fiber coupler 346. The reference arm signal and the sample arm signal are combined in the fiber coupler 346 to generate an interference signal. The interference signal is detected by a balanced receiver, comprising two detectors 348, at each of the outputs of the fiber coupler 346. The electronic interference signal from the balanced receiver 348 is amplified by amplifier 350.

An analog to digital converter system 315 is used to sample the interference signal output from the amplifier 350. Frequency clock and sweep trigger signals derived from the k-clock module 250 of the mode-locked swept source 100 are used by the analog to digital converter system 315 to synchronize system data acquisition with the frequency tuning of the swept source system 100.

Once a complete data set has been collected from the sample 340 by spatially raster scanning the focused probe beam point over the sample, in a Cartesian geometry, x-y, fashion or a cylindrical geometry theta-z fashion, and the spectral response at each one of these points is generated from the frequency tuning of the mode-locked swept source 100, the digital signal processor 380 performs a Fourier transform on the data in order to reconstruct the image and perform a 2D or 3D tomographic reconstruction of the sample 340. This information generated by the digital signal processor 380 can then be displayed on a video monitor.

In one application, the probe is inserted into blood vessels and used to scan the inner wall of arteries and veins. In other examples, other analysis modalities are included in the probe such as intravascular ultrasound (IVUS), forward looking IVUS (FLIVUS), high-intensity focused ultrasound (HIFU), pressure sensing wires and image guided therapeutic devices.

These swept lasers can pulsate naturally without external modulation, but not always stably. See A. Bilenca, S. H. Yun, G. J. Tearney, and B. E. Bouma, “Numerical study of wavelength-swept semiconductor ring lasers: the role of refractive-index nonlinearities in semiconductor optical amplifiers and implications for biomedical imaging applications”, OPTICS LETTERS/Vol. 31, No. 6/Mar. 15, 2006.

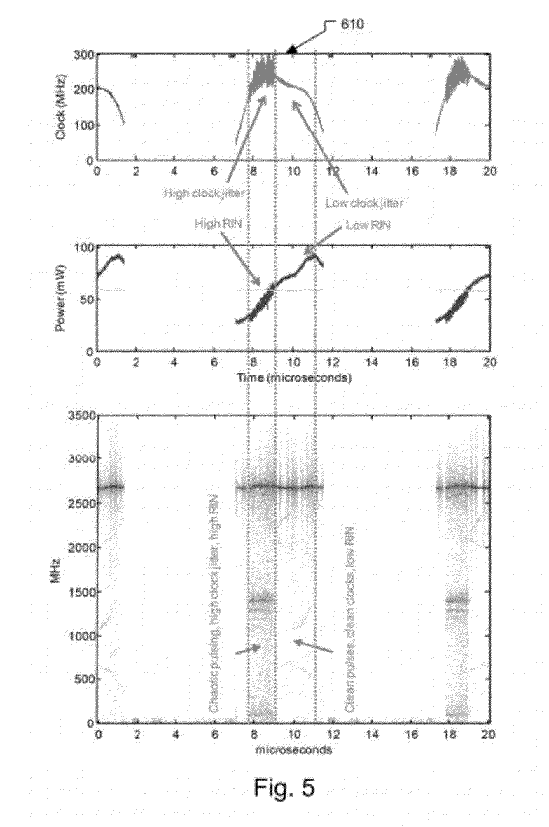

FIG. 5 shows both stable and unstable laser pulsation. The top plot is a plot of k-clock frequency during the frequency scan of the swept source 100. During the scan 610, the high k-clock jitter region is indicative of an unstable pulsation. The unstable clock is accompanied by high relative intensity noise (RIN). The bottom graph in FIG. 5 is a spectrogram of the laser power output as seen on a wide-bandwidth photodiode. It shows the spectral content of the signal in MHz vs. time. Dark regions show intense signals at that particular frequency. In the regions of low clock jitter and low RIN, the laser cleanly pulses twice per round trip. The pulsation frequency is 2.6 GHz, whereas the mode-spacing of the cavity is 1.3 GHz. For stable operation, a laser need only pulsate at the round trip frequency or a harmonic of that frequency, not necessarily at the n=2 harmonic.

Here, in the previously illustrated embodiments, active mode-locking is added to the swept source 100, either through gain modulation or through added intracavity phase modulation. This will guide the pulsation process so that there will be no unstable clock/high RIN regions of operation. The added modulation guides the natural pulsation into a more stable operation by modulating at the cavity round trip frequency, harmonic of the round trip frequency, or with a more complex waveform synchronized to the round trip frequency.

While this invention has been particularly shown and described with references to preferred embodiments thereof, it will be understood by those skilled in the art that various changes in form and details may be made therein without departing from the scope of the invention encompassed by the appended claims. For example, although the invention has been described in connection with an OCT or spectroscopic analysis only, the invention could also be applied along with IVUS, FLIVUS, HIFU, pressure sensing wires and image guided therapeutic devices.

What is claimed is:

1. An optical coherence imaging method, comprising:
providing a tunable laser having a linear cavity;
controlling the linear cavity tunable laser to generate a tunable optical signal in a mode-locked condition;
transmitting the tunable optical signal to an interferometer having a reference arm and a sample arm in which a sample is located;
detecting the tunable optical signal returning from the sample arm and the reference arm; and
generating image information of the sample from the detected tunable optical signal.

2. A method as claimed in claim 1, wherein controlling the linear cavity tunable laser to generate the tunable optical signal in the mode-locked condition comprises controlling a bias current to an optical gain element that amplifies light in the linear cavity.

3. A method as claimed in claim 2, wherein modulating the bias current comprises modulating the bias current at a frequency based on a roundtrip travel time of light in the linear cavity.

4. A method as claimed in claim 1, wherein controlling the linear cavity tunable laser to generate the tunable optical signal in the mode-locked condition comprising modulating gain of the linear cavity.

5. A method as claimed in claim 4, wherein modulating the gain of the linear cavity current comprises modulating the gain at a frequency based on a roundtrip travel time of light in the linear cavity.

6. A method as claimed in claim 1, wherein controlling the linear cavity tunable laser to generate the tunable optical signal in the mode-locked condition comprising modulating phase of optical signals in the linear cavity.

7. A method as claimed in claim 1, further comprising:
configuring the linear cavity to be at least 40 millimeters long; and
tuning the tunable signal over a scan band at greater than 50 kHz.

8. An optical coherence imaging method, comprising:
providing a tunable laser;
controlling the tunable laser to generate a tunable optical signal in a mode-locked condition by modulating a gain or a phase of optical signals in a cavity of the tunable laser with one or more pulses oscillating in the cavity;
transmitting the tunable optical signal to an interferometer having a reference arm and a sample arm in which a sample is located;
detecting the tunable optical signal returning from the sample arm and the reference arm; and
generating image information of the sample from the detected tunable optical signal.

9. A method as claimed in claim 8, wherein controlling the tunable laser to generate the tunable optical signal in the mode-locked condition comprises controlling a bias current to an optical gain element that amplifies light in the cavity.

10. A method as claimed in claim 9, wherein modulating the bias current comprises modulating the bias current at a frequency based on a roundtrip travel time of light in the cavity.

11. A method as claimed in claim 8, wherein controlling the cavity tunable laser to generate the tunable optical signal in the mode-locked condition comprising modulating phase of optical signals in the cavity at a frequency based on a roundtrip travel time of light in the cavity.

12. A method as claimed in claim 8, further comprising:
configuring the cavity to be at least 40 millimeters long; and
tuning the tunable signal over a scan band at greater than 50 kHz.

13. An optical coherence analysis system comprising:
a tunable laser for generating a tunable optical signal that is frequency tuned over a scan band, the tunable laser having a linear cavity and including a mode locking system for constraining the tunable laser to operate in a mode-locked condition as the tunable laser is frequency tuned;
an interferometer for dividing the tunable optical signal between a reference arm and a sample arm leading to a sample; and
a detector system for detecting an interference signal generated from the tunable optical signal from the reference arm and from the sample arm.

14. A system as claimed in claim 13, wherein the tunable laser comprises a semiconductor gain medium and a tuning element for controlling a frequency of the tunable optical signal.

15. A system as claimed in claim 14, wherein the mode locking system comprises a modulated bias current source that supplies a modulated bias current to the semiconductor gain medium.

16. A system as claimed in claim 15, wherein the modulated bias current source comprises a radio frequency signal generator and a bias current source.

17. A system as claimed in claim 16, wherein the radio frequency signal generator modulates at a frequency based on a roundtrip travel time of light in the cavity.

18. A system as claimed in claim 13, wherein the mode locking system comprises a phase modulator in the cavity.

19. A system as claimed in claim 18, wherein the mode locking system further comprising a radio frequency signal generator that generates a modulated signal to the phase modulator.

20. A system as claimed in claim 19, wherein the modulated signal is generated with a frequency based on a roundtrip travel time of light in the linear cavity.

21. A system as claimed in claim 13, wherein the cavity has a length of at least 40 millimeters.

22. A system as claimed in claim 13, wherein the tunable signal is scanned over a scan band at greater than 50 kHz.

23. An actively mode-locked tunable laser, comprising:
a tunable filter in a laser cavity for frequency tuning a tunable signal generated by the tunable laser; and
a semiconductor optical amplifier for amplifying light in the laser cavity and providing four-wave mixing that red shifts light within the cavity facilitating tuning to lower frequencies.
